(19) United States
(12) Patent Application Publication
(10) Pub. No.: US 2022/0268450 A1
(43) Pub. Date: Aug. 25, 2022

(54) DEVICE FOR HEATING COOKING GOODS

(71) Applicant: Wilhelm BRUCKBAUER, Neubeuern (DE)

(72) Inventors: Nikolaus APPEL, Niederndorf (AT); Walter KÖNNEKER, Niederndorf (AT)

(21) Appl. No.: 17/602,417

(22) PCT Filed: Apr. 14, 2020
(86) PCT No.: PCT/EP2020/060413

§ 371 Date: Oct. 8, 2021

(30) Foreign Application Priority Data
Apr. 12, 2019 (DE) 10 2019 205 337.8

(51) Int. Cl. F24C 15/32; F24C 15/20

(52) U.S. Cl. CPC F24C 15/322; F24C 15/2007; F24C 15/2035

(57) ABSTRACT

A device for heating cooking goods comprises a ventilation device which enables different function modes, wherein in one of the function modes a volume flow generated by a fan has a proportion of at least 90% of exhaust air extracted from a receiving space.

### CROSS-REFERENCES TO RELATED APPLICATIONS

This application claims the priority of German patent application, Serial No. DE 10 2019 205 337.8, filed Apr. 12, 2019, the content of which is incorporated herein by reference in its entirety as if fully set forth herein.

### FIELD OF THE INVENTION

The invention relates to a device for heating cooking goods. The invention further relates to a method for operating a device for heating cooking goods.

### BACKGROUND OF THE INVENTION

Baking ovens and steam cookers are known from the prior art in various designs. By way of example, reference is made to DE 27 05 395 A1, DE 44 07 702 A1, DE 101 58 425 C1, U.S. Pat. No. 3,587,555 and EP 1 436 550 B2. There is an ongoing need to further develop such devices.

### SUMMARY OF THE INVENTION

The invention is based on the object of improving a device for heating cooking goods.

This object is achieved by a device for heating cooking goods with
a housing, which surrounds a receiving space for receiving the cooking goods to be heated, which comprises:
a closable opening for loading the receiving space with cooking goods, and, separately therefrom,
   at least one fresh air inlet and
   at least one fluid outlet,
a heating device for direct or indirect transfer of thermal energy to the cooking goods to be heated, and
a controllable ventilation device with
   at least one fan for generating a volume flow,
   a flow guide system arranged outside the receiving space in the housing, for guiding an air flow with fresh air sucked into the housing and/or an air flow with exhaust air extracted from the receiving space,
   at least one means for the purification of exhaust air,
   at least one control means for controlling the extraction of exhaust air from the receiving space,
   at least one control means for controlling a fresh air supply through the at least one fresh air inlet to the receiving space,
   at least one control means for controlling a supply of the air flow of the fresh air sucked into the housing to the air flow of the exhaust air extracted from the receiving space,
wherein the ventilation device allows at least three different function modes:
   a first function mode in which an active fresh air supply to the receiving space is essentially prevented,
   a second function mode, in which both a supply of fresh air to the receiving space and a supply of fresh air to the air flow of the exhaust air extracted from the receiving space is enabled
   a third function mode in which a supply of fresh air to the air flow of the exhaust air extracted from the receiving space is prevented.

The core of the invention is to provide the device with a controllable ventilation device which has at least one control means for controlling the extraction of exhaust air from the receiving space and at least one control means for controlling a fresh air supply through at least one fresh air inlet to the receiving space.

As a result, it is possible to precisely control the atmosphere, in particular the temperature and/or humidity in the receiving space. In particular, it is possible to regulate the atmosphere in the receiving space.

Atmosphere in the receiving space shall be understood to refer to in particular the gaseous medium in the receiving space with its temperature and humidity content.

One particular advantage is that the controllable ventilation device makes it possible to exchange the air in the receiving space quickly, in particular within a few seconds. As a result, it is possible to achieve increased operational reliability. Furthermore, this makes it possible to control the cooking process more precisely, in particular to prevent overcooking at the end or after completion of the cooking process.

According to a further aspect of the invention, the ventilation device enables the exhaust air extracted from the receiving space to be purified. Due to this, undesired odor nuisances and/or impurities may be avoided.

The device is, for example, a baking oven, in particular a steam baking oven, or a steam cooker. It may also be a microwave oven or a combination appliance with a selection of the functions of a baking oven, a steam cooker, and a microwave oven. In general, the device is a kitchen appliance.

According to one aspect of the invention, the ventilation device enables at least three different function modes:
In a first function mode, the fresh air supply to the receiving space is prevented,
in a second function mode, both a supply of fresh air to the receiving space and a supply of fresh air to the air flow of the exhaust air extracted from the receiving space are enabled, and
in a third function mode, a supply of fresh air to the air flow of the exhaust air extracted from the receiving space is prevented.

The third function mode enables in particular a very quick extraction of the exhaust air from the receiving space. This is particularly advantageous for opening the door of the receiving space and/or at the end of the cooking process.

Here and in the following, fresh air is understood to mean air which is sucked into the housing of the device from outside.

Exhaust air is understood to mean air from the receiving space. The exhaust air may in particular comprise vapors, i.e. cooking vapors, and/or steam, in particular also grease-containing steam.

With the aid of the device according to the invention, it is possible to prevent an uncontrolled introduction of the exhaust air into the kitchen. In particular, it is possible to purify the exhaust air before it is conducted out of the housing.

The object according to the invention is further solved by a device for heating cooking goods with
a housing, which surrounds a receiving space for receiving the cooking goods to be heated, which comprises:
   a closable opening for loading the receiving space with cooking goods, and, separately therefrom,
   at least one fresh air inlet and
   at least one exhaust air outlet,
a heating device for direct or indirect transfer of thermal energy to the cooking goods to be heated, and
a controllable ventilation device with
   at least one fan,
   a flow guide system arranged outside the receiving space in the housing, for guiding an air flow with fresh air sucked into the housing and/or an air flow with exhaust air extracted from the receiving space,
   at least one control means for controlling the extraction of the exhaust air from the receiving space,
   at least one control means for controlling a fresh air supply through the at least one fresh air inlet to the receiving space,
   at least one control means for controlling a supply of the air flow of the fresh air sucked into the housing to the air flow of the exhaust air extracted from the receiving space,
wherein the ventilation device allows at least three different function modes:
   a first function mode in which the volume flow generated by the fan has a proportion of at most 10% of exhaust air extracted from the receiving space,
   a second function mode in which the volume flow generated by the fan has a proportion of at least 10% and at most 90% of exhaust air extracted from the receiving space, and
   a third function mode in which the volume flow generated by the fan has a proportion of at least 90% of exhaust air extracted from the receiving space.

The core of the invention is to provide different function modes, which differ in what proportion of the volume flow generated by the fan is formed by the exhaust air extracted from the receiving space.

The indications as to the proportion of the exhaust air extracted from the receiving space in the volume flow generated by the fan here refers to the region of the at least one means for purifying exhaust air, in particular a filter, and/or to the region of an intake opening of the at least one fan for the generation of the volume flow and/or to a region of a housing outlet.

In a first function mode, the volume flow generated by the fan has a proportion of exhaust air extracted from the receiving space of at most 10%. Such a low extraction of exhaust air from the receiving space is advantageous, for example, in the steaming or combined steaming operating mode. In this case, the volume flow may serve primarily for cooling electric or electronic components.

In a second function mode, the proportion of the exhaust air extracted from the receiving space to the volume flow generated by the fan is at least 10% and at most 90%. This is advantageous, for example, for a hot air mode and/or for steam reduction in the receiving space.

In a third function mode, the volume flow generated by the fan has a proportion of at least 90% of exhaust air extracted from the receiving space. This is particularly advantageous for the rapid extraction of the exhaust air from the receiving space and/or for cooling down the receiving space. The extraction of the exhaust air from the receiving space is also referred to as evacuation of the receiving or cooking space. In this case, the term “evacuation” does not imply, at least not necessarily, that a negative pressure is generated in the receiving space.

According to one aspect, one or more of the control means for controlling the extraction of exhaust air from the receiving space, for controlling a fresh air supply through the at least one fresh air inlet to the receiving space, and for controlling a supply of the air flow of fresh air sucked into the housing to the air flow of exhaust air extracted from the receiving space are steplessly controllable. In particular, they may be adjustable between fully open and fully closed. In particular, they may have random intermediate positions. Alternatively, they may also have a predetermined number of discrete positions.

Stepless adjustability enables a more flexible control. Discrete settings may simplify the actuation of the control means.

According to a further aspect of the invention, the ventilation device is configured in such a way as to enable fresh air to be sucked in from the front of the housing. Alternatively or additionally, an intake of fresh air from the rear is also possible. In particular, it is possible to suck in the fresh air, which is fed to the receiving space through the fresh air inlet, from the rear side of the device. In particular, it may be sucked in without a guide.

According to another aspect of the invention, two or more of the control means are directly or indirectly coupled to each other. In particular, it is possible to configure all of the control means as to be coupled to one another. In particular, they may be connected in a signal-transmitting manner to a common central control device. As a result, the operational reliability may be increased. In addition, this may simplify the control.

According to yet another aspect of the invention, one or more of the control means have a regulatable actuator. In particular, they may have a valve and/or a regulating flap and/or one or more air slides. In particular, they may be configured in the form of a valve or a regulating flap.

This enables particularly simple, reliable and robust control of the air flows.

According to a further aspect of the invention, the means for purifying exhaust air has at least one filter module with at least one odor filter.

With the aid of the filter module, the exhaust air generated in the receiving space during the cooking process can be purified during the cooking process. In particular, the exhaust air may be purified of odors and/or grease and/or particles.

This aspect of the invention may also be realized independently of the details of the controllable ventilation device. In particular, a device for heating cooking goods comprising an odor filter constitutes a separate aspect of the invention.

According to another aspect of the invention, the at least one filter module, in particular the odor filter, is removable from the front side of the housing of the device.

According to yet another aspect of the invention, the means for purifying exhaust air, in particular the filter module, in particular the odor filter, is replaceable from the front side of the housing without tools.

This facilitates interchangeability of the cleaning agent.

The cleaning agent, especially the odor filter, may be reprocessed.

In particular, the filter module may be cleaned partially or as a whole.

According to a further aspect of the invention, the means for purifying exhaust air in the flow control system is arranged upstream of the fan in the flow direction.

This prevents contamination of the fan.

According to another aspect of the invention, in the flow path upstream of the filter module, a bypass flap, bypass valve or bypass slide may be arranged, with which an alternative flow path may be opened or closed. In this way, it is possible to bypass the exhaust air past the filter module. This is useful in particular for the third function mode, in which the volume flow generated by the fan has mainly exhaust air extracted from the receiving space. With the help of such an alternative, adjustable flow path the pressure loss, in particular in the third function mode, may be further reduced. Furthermore, as a result, the energy efficiency of the device may be improved in general.

According to a further aspect of the invention, the alternative flow path may be regulated steplessly. In particular, it may be provided parallel to the flow path through the filter module. In this case, it is possible to control, in particular to regulate, in particular to regulate depending on sensor-detected parameters, which portion of the volume flow is conducted through the filter module and which portion is conducted through the bypass.

The filter module, especially the odor filter, may be based on activated carbon, plasma, UV photocatalysis, or a combination of these options.

The odor filter may in particular have a holding element. By means of the holding element, the odor filter can be easily arranged in the device, in particular in the flow guide system,

The odor filter may be cuboid in shape. It may have a length of at least 20 cm, in particular at least 30 cm, in particular at least 40 cm.

It may have a width of at least 5 cm, in particular at least 10 cm, in particular at least 15 cm, in particular at least 18 cm.

It may have a depth of at least 1 cm, in particular at least 2.5 cm, in particular at least 4.8 cm.

These values have proven to be advantageous for providing sufficiently high filtration while keeping flow resistance as low as possible.

According to a further aspect of the invention, the control means for controlling the fresh air supply to the receiving space through the at least one fresh air inlet is coupled in a signal-transmitting manner to a sensor device in the receiving space. By means of the sensor device, for example, the temperature and/or humidity of the atmosphere in the receiving space is detectable.

In this way, it is possible to flexibly and precisely control, in particular regulate, the atmosphere, in particular the temperature and/or humidity, in the receiving space.

According to another aspect of the invention, the control means for controlling the extraction of exhaust air from the receiving space is coupled to a sensor device in the receiving space. This may be the sensor device already mentioned above.

This makes it possible to flexibly and precisely control the extraction of exhaust air from the receiving space.

According to yet another aspect of the invention, the device comprises a controllable pump by means of which exhaust air and/or humidity may be pumped out of the receiving space through the at least one fluid outlet.

This may improve the removal of exhaust air and/or humidity from the receiving space. By means of a separate pump, in particular, an exchange of the atmosphere in the receiving space is possible in a quick and simple manner.

According to a further aspect of the invention, a device for the condensation of water vapor contained in the exhaust air extracted from the receiving space is arranged at the output side of the fluid outlet of the receiving space.

The condensation device may be a condensing device with water cooling. In particular, it is possible to pass the exhaust air through a reservoir with cooling water. This leads to a condensation of water vapor contained in the exhaust air. This also leads to a purification of the exhaust air.

According to another aspect of the invention, lowering the water level in the condensing device during the extraction may increase the fan cross-section. This leads to an increase in the performance of the extraction.

The water reservoir may have a fixed water connection. In particular, it may have a fresh water inlet and a waste water outlet. This also enables easy cleaning of the water reservoir.

According to yet another aspect of the invention, the condensation device can be cleaned together with the receiving space. A special cleaning program may be provided for this purpose.

In particular, the housing may have an inlet opening for sucking in fresh air at the front side or in the region of the front side. This is understood to mean a region with a distance of a maximum of 20 cm, in particular a maximum of 10 cm, in particular a maximum of 5 cm from the front side.

According to a further aspect, the ventilation device is configured to allow exhaust air to be discharged at the rear side of the housing. In particular, the housing may have an outlet opening in the region of its rear side.

An exhaust air guide, in particular in the form of an exhaust air duct system, may join the outlet opening. The duct system may be of modular design. In particular, it may have ventilation ducts and/or ventilation tubes.

In particular, it is possible to flexibly guide the exhaust air from the housing to a separate space region. For example, the exhaust air may be guided to the base region of a kitchen cabinet. In principle, the exhaust air may also be guided away to the outside.

According to another aspect of the invention, the fan is controllable to produce a volume flow in the range of 1 m³/h to 500 m³/h.

According to the invention, it has been found that it is advantageous for rapid extraction of the exhaust air from the receiving space if the fan can generate, at least for a short time, a significantly higher volume flow than the one usually required in normal cooking mode. In the normal cooking mode, the volume flow generated by the fan is in particular in the range of up to 20 m³/h. A volume flow of more than 40 m³/h enables a complete exchange of the atmosphere in the receiving space in less than 15 s, in particular less than 10 s, in particular less than 5 s, in particular less than 3 s.

The volume flow for the evacuation is in particular in the range of 40 m³/h to 80 m³/h. It may also be up to 100 m³/h or more.

The fan for generating the volume flow may in particular be a radial fan. It is also possible to use an axial fan or a cross-flow fan.

According to a further aspect of the invention, the device for heating the cooking goods comprises a control device for controlling the temperature and/or the humidity in the receiving space. In particular, the device for heating the cooking goods may have different heating elements. This enables particularly flexible heating of the cooking goods. In particular, different heating modes are possible.

In accordance with another aspect of the invention, a door for closing the opening for loading the receiving space with cooking goods is coupled in a signal-transmitting manner to a locking device which permits or prevents the door from opening depending on one or more parameters.

The locking device may, for example, be coupled to the aforementioned sensor device in the receiving space. As a result, it is possible to allow the door to the receiving space to be opened only if the temperature and/or humidity in the receiving space is lower than a predefined limit value. In particular, this may prevent a large amount of steam from escaping when the door to the receiving space is opened. Such an escape of steam is usually inconvenient, or even dangerous, for the user.

According to one aspect of the invention, it is intended to evacuate the receiving space before the door is unlocked, i.e. to extract the exhaust air at least as far as possible from the receiving space. For this purpose, the control device may be designed in such a way that in order to open the door such a request must be notified, whereupon the state of the atmosphere in the receiving space is checked by means of the sensor device. If the temperature and/or humidity in the receiving space are lower than a predefined limit value, the door is unlocked; otherwise, the third function mode of the ventilation device is started in order to evacuate the receiving space.

The locking device may, in particular, be an electronic or electronically controlled locking device.

According to a further aspect of the invention, the locking device may be released, in particular unlocked, as required independently of the data detected by means of the sensor device, in particular independently of the temperature and/or humidity in the receiving space. In particular, it may be possible to manually deactivate the locking device in order to allow the door to be opened.

A further object of the invention is to improve a method for operating a device for heating cooking goods.

This object is achieved in that an extraction of exhaust air from the receiving space is carried out in a controlled manner depending on sensor data on the temperature and/or humidity in the receiving space and/or depending on a predetermined operating protocol.

For details, reference is made to the previous description of the device for heating cooking goods.

The method according to the invention may be used, on the one hand, to increase the ease of use and the operating safety. In particular, it may be ensured that no hot steam or at least at most a predetermined maximum amount of steam escapes from the receiving space when the door is opened. Furthermore, an end of the cooking process may be precisely controlled by a targeted extraction of the exhaust air from the receiving space. In particular, an undesired overcooking of the cooking goods may be prevented. For this purpose, the atmosphere in the receiving space can be completely exchanged at the end of the cooking process. Subsequently, a controlled holding at a predefined temperature and/or humidity may be carried out.

Further advantages and details of the invention will be apparent from the description of embodiments based on the figures.

### BRIEF DESCRIPTION OF THE DRAWINGS

FIG. 1 shows a schematic sectional view through a cooking apparatus with a controllable ventilation device in a first function mode,

FIG. 2 shows an illustration according to FIG. 1 in a second function mode, and

FIG. 3 shows an illustration according to FIG. 1 in a third function mode.

### DESCRIPTION OF THE PREFERRED EMBODIMENTS

In the following, the components of the device according to the invention will be described at first. The device is a device for heating cooking goods. It will therefore be referred to as cooking apparatus 1 in the following. In particular, it may be a pressureless cooking apparatus. In particular, it may be a baking oven, a steam cooker, a combination steam cooker, i.e. a baking oven with a steam cooking function, a microwave oven or a combination appliance with a selection from the aforementioned functions.

The cooking apparatus 1 has a housing 2. The housing 2 surrounds a receiving space 3 for receiving the cooking goods to be heated. The receiving space 3 is also referred to as the cooking space.

The housing 2 may be essentially cuboidal in shape. In particular, it may have a front side 4 and a rear side 5. In particular, it has a bottom 6 and an upper side 7. It further has side walls, which are not explicitly shown in the figures.

The housing 2, in particular, has a closable opening 8 for loading the receiving space 3 with cooking goods. The opening 8 can be closed by means of a closure element, in particular in the form of a door 9. The door 9 is in particular a hinged door. In particular, the door can be pivoted about a pivot axis 10. The pivot axis 10 is preferably located in the lower region of the door 9 when it is closed. Alternative arrangements of the door 9 and alternative designs of the closure element are possible.

In addition to and separate from the opening 8 for loading the receiving space 3 with cooking goods, the housing 2 has a fresh air inlet 34 and an exhaust air outlet 12.

The fresh air inlet 34 is preferably arranged in the region of the front side 4 of the housing 2.

The exhaust air outlet 12 is preferably located in the region of the rear side 5 of the housing 2.

The cooking apparatus 1 further comprises a heating device 13, which is shown only schematically in the figures. The heating device 13 serves for direct or indirect transfer of thermal energy to the cooking goods to be heated. The heating device 13 may have one or more heating elements. The heating elements may be arranged inside the receiving space 3 or outside thereof. Corresponding alternatives are known from the prior art, for example from DE 101 58 425 C1.

The cooking apparatus 1 has a means for generating a circulating air flow in the receiving space 3. This means for generating a circulating air flow is shown schematically in the figures as a fan wheel 14. It may preferably be arranged in the region of the rear side of the receiving space 3.

Furthermore, the cooking apparatus 1 comprises a ventilation device. The ventilation device may have a plurality of functions. On the one hand, it may serve to generate an air flow for cooling certain components of the cooking apparatus 1. On the other hand, it may serve to control the aeration and deaeration of the receiving space 3. According to the invention, these functions may be realized by means of one single ventilation device. According to an alternative not shown in the figures, it is also possible to provide at least partially separate ventilation devices for the different functions.

The ventilation device comprises at least one fan 15, shown only schematically in the figures. A radial fan preferably serves as the fan. Alternatively, an axial fan or a cross-flow fan may also serve as the fan. A combination of different fans is also possible. In particular, the ventilation device may comprise one single fan 15 or one single fan unit with one or more fans. For example, it is possible to arrange a plurality of fans side by side in one single fan unit. This may reduce the installation space required for the fan unit, in particular the installation height. In addition, a fan unit of this type can be controlled particularly flexibly.

The fan 15 is preferably arranged in the region of the exhaust air outlet 12.

The fan 15 serves to generate a volume flow V° (here V° denotes the volume flow dV/dt. The volume flow V° that can be generated by means of the fan 15 is in the range of up to 50 m³/h, in particular in the range of up to 100 m³/h, in particular in the range of up to 200 m³/h, in particular in the range of up to 300 m³/h, in particular in the range of up to 500 m³/h.

Furthermore, the ventilation device comprises a flow guide system 16. The flow guide system 16 comprises a first partial system for guiding a flow of cooling air 17. In particular, the cooling air 17 is generated by fresh air sucked into the housing 2 through the fresh air inlet 11.

The cooling air 17 is guided in a meandering manner through the flow guide system 16. In particular, starting from the fresh air inlet 11 from the front side 4 of the housing 2, it is first guided along the upper side of the receiving space 3 into the rear region of the housing 2. It is then redirected and guided back into the region of the front side 4 of the housing 2. There it is redirected once again and guided to the exhaust air outlet 12 at the rear side 5 of the housing 2. A larger number of redirections, in particular a larger number of meander loops, is also possible.

The cooling air 17 is guided into the flow guide system 16, in particular from the front. The exhaust air 18 is guided into the flow guide system 16, in particular from the rear.

In order to minimize the pressure loss in the flow guide system 16, preferably as few redirections as possible are provided and the flow paths are designed to be as short as possible.

The cooling air flow is shown schematically by continuous arrows in the figures.

Further, the flow guide system 16 includes a partial system for guiding a flow of exhaust air 18 extracted from the receiving space 3. The exhaust air flow is schematically shown by dashed arrows in the figures.

The cooling air 17 sucked in through the fresh air inlet 11 may be fed to the region of the flow guide system 16 with the flow of the extracted exhaust air 18 via a feed opening 33.

The flow guide system 16 thus serves to guide the air flow with fresh air sucked into the housing 2 and/or to guide the air flow with exhaust air 18 sucked out of the receiving space 3.

The two partial systems partly overlap. In particular, it is intended to feed the air flow with the cooling air 17 in a controlled manner to the air flow of the exhaust air 18 extracted from the receiving space 3.

For controlling the air flows in the housing 2, the ventilation device has a control means for controlling the extraction of the exhaust air 18 from the receiving space 3. In particular, a controllable valve 19 may serve as the control means for controlling the extraction of the exhaust air 18 from the receiving space 3. The valve 19 is arranged in the region of a fluid outlet 20 in the bottom of the receiving space 3.

On the downstream side of the fluid outlet 20, a device for the condensation of water vapor contained in the exhaust air extracted from the receiving space 3 is arranged. The condensation device 28 comprises a duct system with meandering ducts. Cooling water 29 is arranged in the duct system. A fresh water inlet 30 serves for filling the condensation device 28 with cooling water 29. A waste water line 31 serves for emptying the condensation device 28.

The fresh water inlet 30 and the waste water line 31 are shown only schematically in the figures. Together they are referred to as the fixed water connection. The fixed water connection may also be used for cleaning the receiving space 3. For this purpose, the cooking apparatus 1 may have a special cleaning program. This enables automated cleaning of the receiving space 3.

For details of the condensation device 28, reference is made to DE 10 2008 012 961 A1 by way of example.

The valve 19 is connected in a signal-transmitting manner to a central control device 21. The central control device 21 is arranged in an encapsulated electronics housing 22. The electronics housing 22 is designed to be encapsulated in a liquid-tight, in particular vapor-tight, manner. The electronics housing 22 is arranged in particular in the flow guide system 16, in particular in the partial system for guiding the cooling air 17. The cooling air 17 thus serves for cooling the electronics housing 22, in particular the electric and/or electronic components arranged therein. All electric and electronic components for controlling the cooking apparatus 1 may be arranged in the electronics housing 22.

As shown in the figures, the electronics housing 22 may be arranged above the receiving space 3, in particular in the region of the upper side 7 of the housing 2. Alternatively, it is possible to arrange the electronics housing 22 below the receiving space 3, in particular in the region of the bottom 6 of the housing 2. This may provide improved protection against overheating of the electric and/or electronic components.

The ventilation device further comprises a control means for controlling the fresh air supply to the receiving space 3. A fan flap 23 or a valve or, in general, a regulating element, in particular an adjustable regulating element, serves as the control means for controlling the fresh air supply to the receiving space 3.

The fan flap 23 can be used to close a fresh air opening 34 through which fresh air can be fed to the receiving space 3. Fresh air may be fed to the receiving space 3 from the rear side of the device. The fresh air fed to the receiving space 3 may be supplied from the rear side of the unit, in particular without a guide. In particular, it may be supplied via a flow path which is not in flow communication with the fresh air inlet 11. The fresh air fed to the receiving space 3 is in particular independent of the cooling air 17 sucked in through the fresh air inlet 11.

The control means for controlling the fresh air supply to the receiving space 3 is connected to the central control device 21 in a signal-transmitting manner.

The control means for controlling the fresh air supply to the receiving space 3 is arranged, for example, in the region of the rear side of the receiving space 3. Other arrangements are also possible.

In addition, the ventilation device comprises at least one control means for controlling the supply of the air flow of the cooling air 17 sucked into the housing 2 to the air flow of the exhaust air 18 extracted from the receiving space 3. This control means is preferably designed as an adjustable flap 24. It may also be designed as a valve, in particular as a multi-way valve, in particular with at least two inlets and one outlet.

The closure flap 24 is connected to the central control device 21 in a signal-transmitting manner.

Preferably, all control means of the ventilation device are directly or indirectly coupled to each other. They are preferably all connected in each case to the central control device 21 in a signal-transmitting manner.

Furthermore, the cooking apparatus 1, in particular the ventilation device, comprises a means for purifying exhaust air. The means for purifying exhaust air is a filter module 25. The filter module 25 comprises in particular an odor filter. It may also comprise a grease filter and/or further filters. The filter module 25 is arranged in particular in the region of the front side 4 of the cooking apparatus 1. In particular, it is arranged behind a removable front panel 26.

The filter module 25 is preferably removable from the housing 2. In particular, it can be replaced. In particular, the filter module 25 can be removed from the housing 2 without tools. This facilitates the replacement of the filter module 25.

The filter module 25 is arranged in the flow guide system 16 in such a way that both the exhaust air 18 and the cooling air 17 flow through it.

The filter module 25 is arranged upstream of the electronics housing 22 in the direction of flow. Purified air thus flows around the electronics housing 22 during the operation of the cooking apparatus 1, in particular during the operation of the ventilation device.

The filter module 25 is arranged in particular upstream of the fan 15 in the direction of flow. The fan 15 is thus exposed to purified air during the operation of the ventilation device.

In the flow guide system 16, a sensor device 35 for detecting the temperature and/or humidity of the volume flow V° generated by means of the fan 15 may be arranged. The sensor device 35 is arranged, for example, in the region of the filter module 25. It may also be arranged in the region of the electronics housing 22 or in the region of the fan 15. It is preferably arranged on the upstream side of the fan 15.

The sensor device 35 is preferably arranged on the downstream side of the feed opening 33, in particular at a distance therefrom.

The details of the ventilation device, and in particular the details of the filter module 25, are advantageous independently of the other details of the cooking apparatus 1, and in themselves lead to an improvement in a device for heating cooking goods.

The front panel 26 may in particular have a display and/or an operating device with one or more operating elements. This may in particular be a touch-sensitive display (touch display).

In particular, the display may have a very heavily tinted front glass (black panel effect). As a result, contours between a display, neighboring functional components such as capacitive keys and a housing or spaced typing are not visible.

In addition, the cooking apparatus 1 comprises a sensor device 27 arranged in the receiving space 3. The sensor device 27 comprises at least one sensor for detecting the temperature and/or the humidity in the receiving space 3. The sensor device 27 is connected to the central control device 21 in a signal-transmitting manner. With the aid of the sensor device 27, in particular, a feedback control of the control means of the ventilation device, in particular of the fan flap 23 and/or of the valve 19 and/or of the flap 24, is possible.

Moreover, the cooking apparatus 1 has a device 32, also shown only schematically, for controlling the humidity in the receiving space 3. The device 32 for controlling the humidity in the receiving space 3 is preferably connected to the fixed water connection.

In the following, various functions of the cooking apparatus 1 and a method for operating it are described.

The cooking apparatus 1 has different function modes. The different function modes differ in particular in the proportion of the exhaust air 18 extracted from the receiving space 3 to the volumetric flow V° generated by the fan 15.

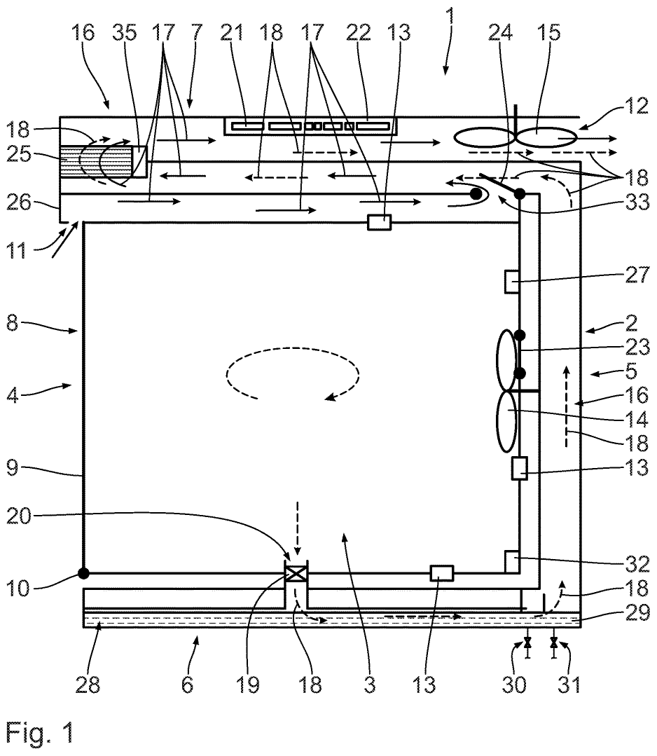

In a first function mode, which is shown in FIG. 1, the proportion of the exhaust air 18 extracted from the receiving space 3 to the total volume flow V° generated by the fan 15 is at most 10%. In other words, in this function mode, the fan 15 essentially exclusively sucks in fresh air through the fresh air inlet 11. The fresh air is guided past the electronics housing 22 by the flow guide system 16. It is primarily serves for cooling the electronics housing 22 and, in particular, the electric/electronic components arranged therein.

In this function mode, the fan flap 23 to the receiving space 3 is essentially closed. However, it may be passively actuated. This shall be understood to mean that it allows fresh air to flow into the receiving space 3 when a certain negative pressure is reached in the receiving space 3.

The fluid outlet 20 may always be open. Alternatively, the fluid outlet 20 may be substantially closed in the first function mode. In this case, it is controllable, in particular adjustable, preferably by means of a controllable valve.

A passive escape of fluids from the receiving space 3 is also possible in the first function mode, for example for pressure compensation. It is also possible to continuously convey a relatively low volume flow of exhaust air 18 out of the receiving space 3. Due to this, a constant, continuous circulation of the atmosphere in the receiving space 3 is possible. This may be advantageous for detecting and controlling, in particular regulating, the temperature and/or humidity in the receiving space 3. In particular, this may improve the control of the cooking process.

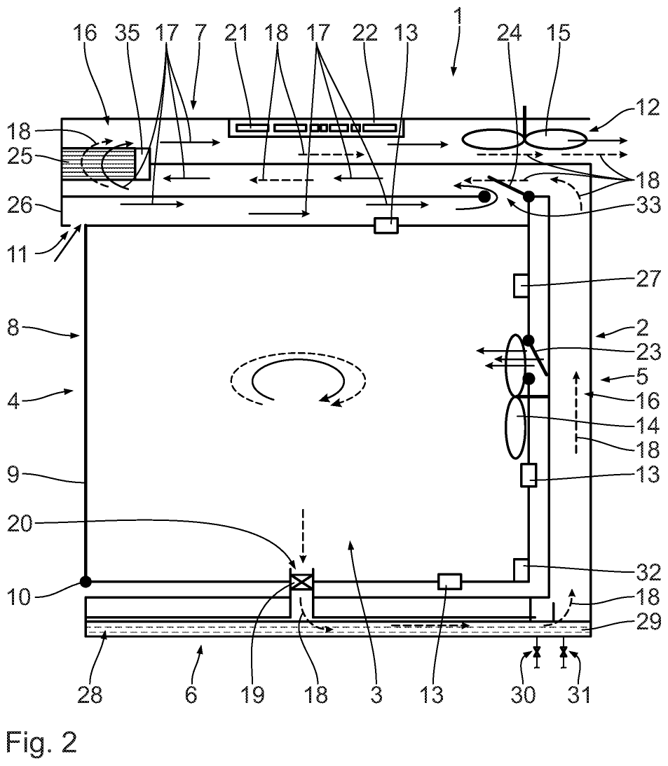

In a second function mode, which is shown schematically in FIG. 2, the proportion of the exhaust air 18 extracted from the receiving space 3 to the total volume flow V° generated by the fan 15 is at least 10% and at most 90%. In particular, it may be in the range of 20% to 80%.

This function mode serves in particular for reducing the steam content in the receiving space 3. It is particularly advantageous during hot-air operation of the cooking apparatus 1.

In this function mode, both a supply of fresh air to the receiving space 3 and a supply of fresh air to the air flow of the exhaust air 18 extracted from the receiving space 3 are possible.

In this function mode, the fan flap 23 is open. In particular, fresh air may be actively fed to the receiving space 3. Exhaust air may also be actively extracted or pumped out of the receiving space 3 through the fluid outlet 20.

In this function mode, the adjustable flap 24 is in a position which allows the fresh air 17 sucked in through the fresh air inlet 11 to be fed to the air flow of the exhaust air 18. The feed opening 33 is at least partially open.

The feed opening 33 can be closed by means of the adjustable flap 24. In particular, it can be completely closed by means of the adjustable flap 24. In this case, a supply of cooling air 17 to the exhaust air flow is prevented.

The feed opening 33 can also be partially closed by means of the adjustable flap 24. This allows the proportion of cooling air 17 in the volume flow generated by the fan 15 to be regulated.

Accordingly, the proportion of exhaust air 18 in the volume flow V° generated by the fan 15 may be regulated with the aid of the adjustable flap 24.

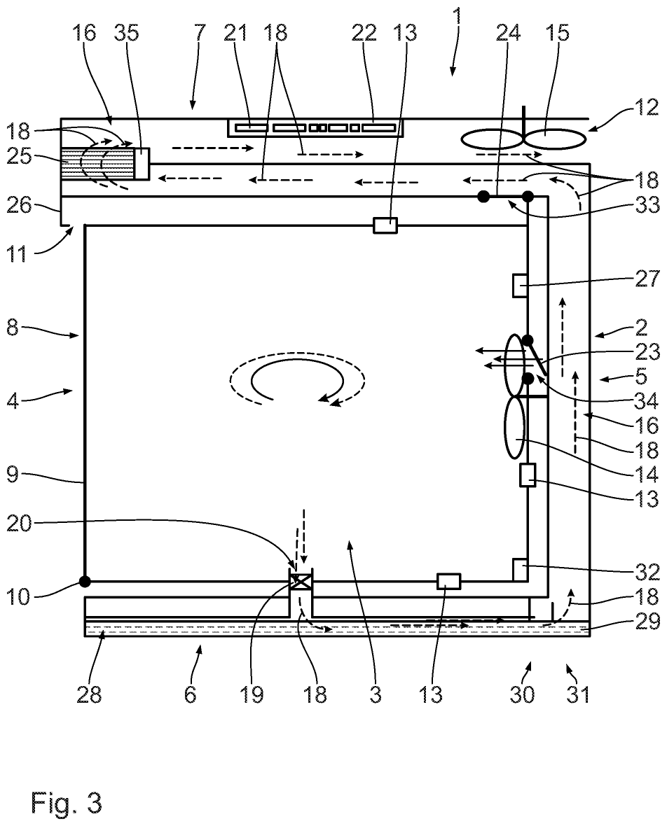

In a third function mode, which is shown in FIG. 3, the proportion of the exhaust air 18 extracted from the receiving space to the volume flow V° generated by the fan 15 is at least 90%.

This mode serves for rapid emptying of the receiving space 3. In particular, it enables rapid reduction of the steam content in the receiving space 3. In particular, it enables rapid cooling of the atmosphere in the receiving space 3.

This is in particular advantageous for precisely controlling an end of the cooking process.

This is further advantageous to prevent a large amount of hot steam from escaping when the door 9 to the receiving space 3 is opened.

In this function mode, a supply, in particular a direct supply of fresh air, to the air flow of the exhaust air 18 extracted from the receiving space 3 is prevented. The feed opening 33 is completely closed by means of the adjustable flap 24.

Optionally, the extraction of exhaust air from the receiving space 3 by the fan 15 may be supported by additional means in this function mode. For example, one or more additional fans may be provided to generate a stronger volume flow. It is also possible to actively remove fluid from the receiving space 3. For this purpose, fluid, in particular exhaust air containing steam, may be pumped out of the receiving space 3. This may take place, for example, with the aid of a pump, not shown in the figures.

A rapid exchange of the atmosphere in the receiving space 3 may also be supported by actively introducing fresh air into the receiving space 3. The fresh air may be fed to the receiving space 3 in particular via the fresh air opening 34.

In this function mode, a direct supply of cooling air 17 to the volume flow of the exhaust air 18 may be prevented. This enables the exhaust air to be sucked out of the receiving space 3 more quickly. On the other hand, this prevents the cooling function of the cooling air 17 sucked in. It may therefore be provided to enable the third function mode in each case only for a predetermined maximum duration in the range of a few seconds to a few minutes. In particular, the maximum duration may be in the range of 3 s to 3 min, in particular in the range of up to 2 min, in particular up to 1 min, in particular up to 30 s, in particular up to 20 s, in particular up to 10 s. Subsequently, a forced opening of the adjustable flap 24 may take place. This state may be provided in particular at least until the temperature and/or humidity of the volume flow in the region of the filter module 25, in particular in the region of the sensor device 35, has reached predetermined values.

In the following, further details of the cooking apparatus 1 or its operation are described in keywords.

With the aid of the adjustable flap 24, it is particularly controllable which mixing ratio of fresh air 17 and exhaust air 18 is passed through the filter module 25. It has been found that this allows the temperature and the relative humidity of the fluid passed through the filter module 25 to be controlled. This may be beneficial for an efficient purification of the exhaust air flow.

With the aid of the filter module 25, the exhaust air 18 extracted from the receiving space 3 can be purified. In particular, it may be purified of grease and/or odor and/or particle proportions contained therein.

By an appropriate actuation of the various control means of the ventilation device, the cooling air flow and the atmosphere in the receiving space 3 may be controlled essentially independently of one another. According to the invention, only one single, common fan 15 is required for this purpose.

The rapid extraction of the steam-containing exhaust air from the receiving space 3 makes it possible to prevent hot steam-containing exhaust air from escaping when the receiving space 3 is opened at the front of the apparatus. This may improve the operation of the apparatus.

By constant purification of the exhaust air 18 with the aid of the filter module 25, odor nuisance during the cooking process may be reduced, in particular prevented. This leads to an improvement of the air quality in the kitchen, respectively of the air quality in the living room in general.

The control means, in particular the adjustable flap 24 and/or the fan flap 23 and/or the valve 19, may be motor-controlled. This enables a particularly flexible control with the aid of the central control device 21.

1. A device for heating cooking goods, the device comprising
1.1. a housing, which surrounds a receiving space for receiving the cooking goods to be heated, which comprises:
1.1.1. a closable opening for loading the receiving space with cooking goods, and, separately therefrom,
1.1.2. at least one fresh air inlet and
1.1.3. at least one fluid outlet,
1.2. a heating device for one of direct and indirect transfer of thermal energy to the cooking goods to be heated, and
1.3. a controllable ventilation device comprising
1.3.1. at least one fan for generating a volume flow,
1.3.2. a flow guide system arranged outside the receiving space in the housing, for guiding at least one of an air flow with fresh air sucked into the housing and/or an air flow with exhaust air extracted from the receiving space,
1.3.3. at least one means for the purification of exhaust air,
1.3.4. at least one extraction control means for controlling the extraction of exhaust air from the receiving space,
1.3.5. at least one inlet control means for controlling a fresh air supply through the at least one fresh air inlet to the receiving space,
1.3.6. at least one supply control means for controlling a supply of the air flow of the fresh air sucked into the housing to the air flow of the exhaust air extracted from the receiving space,
1.4. wherein the ventilation device allows at least three different function modes:
1.4.1. a first function mode in which an active fresh air supply to the receiving space is essentially prevented,
1.4.2. a second function mode, in which both a supply of fresh air to the receiving space and a supply of fresh air to the air flow of the exhaust air extracted from the receiving space is enabled
1.4.3. a third function mode in which a supply of fresh air to the air flow of the exhaust air extracted from the receiving space is prevented.

2. A device for heating cooking goods, the device comprising
2.1. a housing, which surrounds a receiving space for receiving the cooking goods to be heated, which comprises:
2.1.1. a closable opening for loading the receiving space with cooking goods, and, separately therefrom,
2.1.2. at least one fresh air inlet and
2.1.3. at least one exhaust air outlet,
2.2. a heating device for one of direct and indirect transfer of thermal energy to the cooking goods to be heated, and
2.3. a controllable ventilation device with
2.3.1. at least one fan,
2.3.2. a flow guide system arranged outside the receiving space in the housing, for guiding at least one of an air flow with fresh air sucked into the housing and/or an air flow with exhaust air extracted from the receiving space,
2.3.3. at least one control means for controlling the extraction of the exhaust air from the receiving space,
2.3.4. at least one control means for controlling a fresh air supply through the at least one fresh air inlet to the receiving space,
2.3.5. at least one control means for controlling a supply of the air flow of the fresh air sucked into the housing extracted from the receiving space,
2.4. wherein the ventilation device allows at least three different function modes:
2.4.1. a first function mode in which the volume flow generated by the fan has a proportion of at most 10% of exhaust air extracted from the receiving space,
2.4.2. a second function mode in which the volume flow generated by the fan has a proportion of at least 10% and at most 90% of exhaust air extracted from the receiving space, and
2.4.3. a third function mode in which the volume flow generated by the fan has a proportion of at least 90% of exhaust air extracted from the receiving space.

3. A device according to claim 1, wherein at least one of the extraction control means, the inlet control means and the supply control means are steplessly controllable.

4. A device according to claim 1, wherein at least two of the extraction control means, the inlet control means and the supply control means are directly or indirectly coupled to each other.

5. A device according to claim 1, wherein at least one of the extraction control means, the inlet control means and the supply control means has a regulatable actuator.

6. A device according to claim 1, further comprising a means for the purification of exhaust air, which has at least one filter module with at least one odor filter.

7. A device according to claim 1, further comprising a means for the purification of exhaust air, which can be replaced without tools from the front side of the housing.

8. A device according to claim 1, further comprising a means for the purification of exhaust air, which is arranged in the flow guide system upstream of the fan in the direction of flow.

9. A device according to claim 1, wherein the supply control means for controlling the fresh air supply through the at least one fresh air inlet to the receiving space is coupled in a signal-transmitting manner to a sensor device in the receiving space.

10. A device according to claim 1, wherein a device for the condensation of water vapor contained in the exhaust air extracted from the receiving space is arranged on the outlet side of the fluid outlet of the receiving space.

11. A device according to claim 1, wherein the fan for generating a volume flow is controllable in the range of 1 m³/h to 200 m³/h.

12. A device according to claim 1, wherein a door for closing the opening for loading the receiving space with cooking goods is coupled in a signal-transmitting manner to a locking device which permits or prevents an opening of the door depending on one or more parameters.

13. A method for operating a device for heating cooking goods, comprising the following steps:
13.1. providing a device for heating cooking goods with
13.1.1. a receiving space with a closable opening for loading the receiving space with cooking goods to be heated and
13.1.2. a controllable ventilation device with at least one control means for controlling the extraction of exhaust air from the receiving space
13.2. heating the cooking goods in the receiving space,
13.3. extraction of exhaust air from the receiving space,
13.4. wherein the extraction of the exhaust air from the receiving space is carried out in a controlled manner at least one of depending on sensor data on at least one of the temperature and the humidity in the receiving space and depending on a predetermined operating protocol.

14. A method according to claim 13, wherein opening the receiving space is only made possible after a locking device has been released.
